(19) United States
(12) Patent Application Publication
(10) Pub. No.: US 2016/0142670 A1
(43) Pub. Date: May 19, 2016

(54) INFORMATION PROCESSING APPARATUS, SURVEILLANCE CAMERA APPARATUS, AND IMAGE REPRODUCTION APPARATUS

(71) Applicant: Kabushiki Kaisha Toshiba, Tokyo (JP)

(72) Inventor: Tomoki Watanabe, Inagi Tokyo (JP)

(21) Appl. No.: 15/006,937

(22) Filed: Jan. 26, 2016

Related U.S. Application Data
(63) Continuation of application No. PCT/JP2014/072861, filed on Aug. 26, 2014.

(30) Foreign Application Priority Data
Aug. 27, 2013 (JP) 2013-176137

(51) Int. Cl. H04N 5/91; H04N 5/775; H04N 5/38; H04N 7/18

(52) U.S. Cl. CPC H04N 5/91; H04N 7/18; H04N 5/775; H04N 5/38

(57) ABSTRACT

According to an embodiment, an information processing apparatus includes a division unit, a redundancy unit, and a communication unit. The division unit is configured to divide a digital data item, into a plurality of division data items. The redundancy unit is configured to generate at least one redundancy data item for data restoration based on the plurality of division data items. The communication unit is configured to transmit to a plurality of external devices two or more of three or more distribution data items, the three or more distribution data items corresponding to the plurality of division data items and the at least one redundancy data item.

### CROSS-REFERENCE TO RELATED APPLICATIONS

This application is Continuation application of PCT Application No. PCT/JP2014/072861, filed Aug. 26, 2014 and based upon and claiming the benefit of priority from Japanese Patent Application No. 2013-176137, filed Aug. 27, 2013, the entire contents of all of which are incorporated herein by reference.

### FIELD

Embodiments described herein relate generally to an information processing apparatus, a surveillance camera apparatus, and an image reproduction apparatus.

### BACKGROUND

In recent years, surveillance camera apparatuses have been installed everywhere, such as on streets and in buildings. In some surveillance camera apparatuses, image data is stored in built-in memories. The image data acquired by the surveillance camera apparatuses is personal information in a broad sense. If a surveillance camera apparatus is stolen by a malicious person, and the image data is publicized, for example, on video sites on the Internet, a company's reputation could be degraded. Thus, measures need to be taken against divulgence of information due to theft of surveillance camera apparatuses. Further, in this case, information stored in the surveillance camera apparatus, such as image data for identifying who stole the surveillance camera apparatus, is also lost.

Regarding information processing apparatuses such as surveillance camera apparatuses, there has been a demand for prevention of divulgence and loss of information due to theft.

### BRIEF DESCRIPTION OF THE DRAWINGS

FIG. 1 is a block diagram illustrating a surveillance system including a plurality of surveillance camera apparatuses and an image reproduction apparatus according to an embodiment.

FIG. 2 is a block diagram illustrating a configuration example of a redundancy unit illustrated in FIG. 1.

FIG. 3 is a flowchart illustrating a process procedure of the surveillance camera apparatuses illustrated in FIG. 1.

FIG. 4 is a schematic view illustrating an example of the operation of the surveillance camera apparatuses illustrated in FIG. 1.

FIG. 5 is a flowchart illustrating a process procedure of an image reproduction apparatus illustrated in FIG. 1.

FIG. 6 is a flowchart illustrating an example of a division data acquisition process illustrated in FIG. 5.

FIG. 7 is a flowchart illustrating an example of a redundancy data acquisition process illustrated in FIG. 5.

FIG. 8 is a schematic view illustrating an example of the operation of the image reproduction apparatus illustrated in FIG. 1.

FIG. 9 is a schematic view illustrating an example of distributed storage of image data items.

### DETAILED DESCRIPTION

In general, according to an embodiment, an information processing apparatus includes a division unit, a redundancy unit, and a communication unit. The division unit is configured to divide a digital data item into a plurality of division data items. The redundancy unit is configured to generate at least one redundancy data item for data restoration based on the plurality of division data items. The communication unit is configured to transmit to a plurality of external devices two or more of three or more distribution data items, the three or more distribution data items corresponding to the plurality of division data items and the at least one redundancy data item.

Embodiments will be described hereinafter with reference to the accompanying drawings. In the embodiments, like reference numbers denote like elements, and a repetitive explanation will be omitted.

FIG. 1 schematically illustrates a surveillance system 100 according to an embodiment. As shown in FIG. 1, the surveillance system 100 includes an M-number of surveillance camera apparatuses 110-1, 110-2, . . . , 110-M, and an image reproduction apparatus 120. In this case, M is an integer of 3 or more. The surveillance camera apparatuses 110-1, 110-2, . . . , 110-M, and the image reproduction apparatus 120 are mutually connected via a network 130. The network 130 includes a wired network, a wireless network, or a combination of a wired network and a wireless network. In FIG. 1, although the surveillance camera apparatuses 110-2, . . . , 110-M are depicted in a simplified manner, the surveillance camera apparatuses 110-2, . . . , 110-M may have the same configuration as the surveillance camera apparatus 110-1. In the description below, when the surveillance camera apparatuses 110-1, 110-2, . . . , 110-M are not distinguished, these are described as the surveillance camera apparatus 110.

The surveillance camera apparatus 110 is configured to capture an image of a predetermined surveillance area, and the image reproduction apparatus 120 is configured to reproduce an image captured by the surveillance camera apparatus 110. In an example in which the surveillance system 100 is introduced in a facility (e.g., an office building or a commercial establishment), the surveillance camera apparatus 110 is installed at a predetermined position, so as to capture an image of a surveillance area such as an entrance/exit, a passage, a room, an elevator, or a parking lot.

The surveillance camera apparatus 110 includes an imaging unit 111, a division unit 112, a redundancy unit 113, a storage unit 114, a communication unit 115, and a random number generator 116. The imaging unit 111 includes a sensor to capture an image, and generates an image data item by capturing an image of the surveillance area. The image data item may be a data item of a still image or a data item of a moving image.

The division unit 112 divides the image data item generated by the imaging unit 111, and generates a plurality (N) of division data items. The division number N, by which the image data, item is divided, is a predetermined integer value of 2 or more. In the present embodiment, the division unit 112 divides the image data item such that the N-number of division data items are equal in bit length. In another embodiment, the division unit 112 may divide the image data item such that at least one division data item has a bit number which is different from those of other division data items.

The redundancy unit 113 generates at least one redundancy data item for data restoration based on the plurality of division data items generated by the division unit 112. The redundancy data item is information which is used in order to restore, when a certain division data item has been lost, this lost division data item based on the other division data items. Examples of a method of generating a redundancy data item include a method of generating a redundancy data item which enables data restoration only when one division data item has been lost, and a method of generating a redundancy data item which enables data restoration even when a plurality of division data items have been lost. Concrete methods of generating a redundancy data item will be described later.

In the present embodiment, the image data item, which is generated by the imaging unit 111, is stored, as a plurality of division data items and at least one redundancy data item, in a distributed manner in the surveillance camera apparatuses on the network 130. Hereinafter, the division data items and the redundancy data item are also collectively referred to as “distribution data items”.

The storage unit 114 stores data. Specifically, the storage unit 114 stores at least one of three or more distribution data items which corresponds to the plurality of division data items generated by the division unit 112 and the at least one redundancy data item generated by the redundancy unit 113. Further, the storage unit 114 stores a distribution data item (a division data item or a redundancy data item) which is received from another surveillance apparatus 110 via the communication unit 115 to be described later. The storage unit 114 can store each distribution data item, together with identification data (ID) for identifying the surveillance camera apparatus 110 which captures an image corresponding to this distribution data item, as well as the time at which the image is captured. The storage unit 114 may be realized by a recording medium (e.g., flash memory) which is built into the surveillance camera apparatus 110, or by a removable recording medium such as a memory card.

The communication unit 115 communicates with the other surveillance camera apparatuses 110 which are connected via the network 130, and transmits/receives data to/from the other surveillance camera apparatuses 110. The communication unit 115 transmits to a plurality of surveillance camera apparatuses 110 two or more distribution data items which are other than the distribution data item stored in the storage unit 114 among three or more distribution data items. Transmission destinations (storage destinations) of the distribution data items may be predetermined, or may be changed at random. When the transmission destinations are changed at random, the communication unit 115 may determine the transmission destinations in accordance with random numbers which are generated by the random number generator 116. The communication unit 115 receives distribution data items from other surveillance camera apparatuses 110, and stores the received distribution data items in the storage unit 114. Further, the communication unit 115 communicates with the image reproduction apparatus 120 which is connected via the network 130. Responding to a request from the image reproduction apparatus 120, the communication unit 115 transmits the distribution data item, which is stored in the storage unit 114, to the image reproduction apparatus 120.

In the above-described embodiment, the surveillance camera apparatus 110 stores at least one of the distribution data items generated by this surveillance camera apparatus 110, in the storage unit 114 of this surveillance camera apparatus 110. Alternatively, the surveillance camera, apparatus 110 may transmit all the distribution data items generated by this surveillance camera apparatus 110, to other surveillance camera apparatuses 110, without storing the distribution data item in the storage unit 114 of this surveillance camera apparatus 110.

The methods by which the redundancy unit 113 generates a redundancy data item will now be concretely described.

In a first method example, an exclusive OR (XOR) is utilized. For example, the redundancy unit 113 generates a redundancy data item by performing a bitwise exclusive OR operation on N division data items. For the purpose of simple description, a description is given of the case of dividing an image data item into three division data items, A, B and C, each of equal bit length. A redundancy data item α is calculated, for example, in accordance with α=ÂB̂C. Symbol “̂” is an operator representative of an exclusive OR. For example, when a division data item C is lost, the division data item C can be restored from the division data items A and B and the redundancy data item α, using C=ÂB̂α. Also, when another division data item (e.g., a division data item A) is lost, or when the division number N is different, the above-described restoration operation holds true in general.

In the above-described case, one redundancy data item is generated from all the division data items obtained by dividing the image data item. However, the generation method using the exclusive OR is not limited to this. For example, the redundancy unit 113 may classify the division data items into a plurality of groups, and may perform a bitwise exclusive OR operation on the division data items in units of groups.

In an example, when an image data item is divided into four division data items, A, B, C and D, the redundancy unit 113 generates a redundancy data item α1 by performing a bitwise exclusive OR operation on the division data items A and B, and generates a redundancy data item α2 by performing a bitwise exclusive OR operation on the division data items C and D. In this example, there is a case in which data restoration is also enabled when a plurality of division data items is lost. For example, when two division data items, B and C, is lost, the division data item B can be restored from the division data item A and the redundancy data item α1, and the division data item C can be restored from the division data item D and the redundancy data item α2. Note that a common division data item may be included in a plurality of groups For example, four division data items, A, B, C and D, may be classified into a first group including division data items A, B and C, and a second group including division data items B, C and D.

In a second method example, use is made of a redundancy method which is used in a system called RAID6 of RAID (Redundant Arrays of Inexpensive Disks). RAID is a technique in which a plurality of hard disks are mounted on one computer and data is made redundant and distributively stored in the hard disks, thereby avoiding loss of data even when a failure has occurred in a hard disk. RAID is generally used in server computers. In RAID6, redundancy data of two kinds, namely a horizontal parity and a vertical parity, are generated, whereby data restoration is enabled even if data of two hard disks are lost.

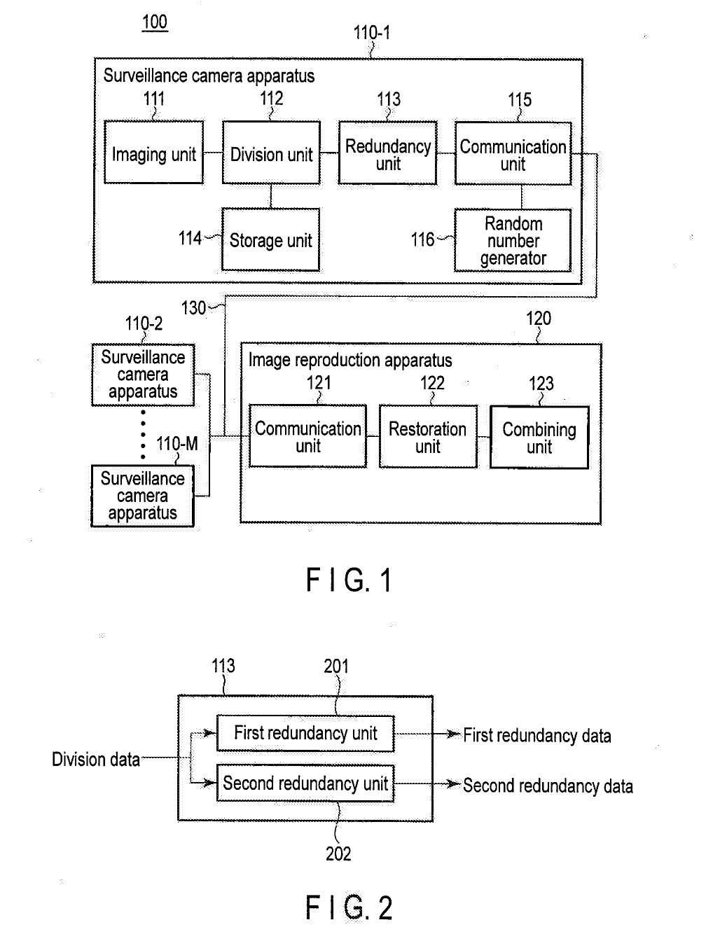

FIG. 2 illustrates an example of the redundancy unit 113 configured to generate two kinds of redundancy data. In the example shown in FIG. 2, the redundancy unit 113 includes a first redundancy unit 201 and a second redundancy unit 202. The first redundancy unit 201 generates a first redundancy data item in accordance with the above-described first method example. Specifically, the first redundancy unit 201 generates a first redundancy data item by performing a bitwise exclusive OR operation on the plurality of division data items. The second redundancy unit 202 generates a cyclic redundancy check (CRC) code for the plurality of division data items, and outputs the generated CRC code as a second redundancy data item.

The first redundancy data item is calculated by a bitwise exclusive OR operation on the plurality of division data items. The second redundancy data item is calculated as the polynomial remainder in a weighted Galois field GF (2), that is, an 8-bit CRC. The CRC is an error detection code and does not have an error correction capability. However, if certain conditions are satisfied, error correction can be made, and these conditions are satisfied in RAID6. Due to the restriction of the 8-bit CRC, the division number needs to be 255 or less.

For example, when image data item is divided into four division data items, A, B, C and D, a first redundancy data item α and a second redundancy data item β are generated by the following equations (1) and (2):

α=A+B+C+D (1)

β=CRC(A+B*2+C*4+D*8) (2)

where A, B, C, D, α, and β are 1-byte data items, and CRC(x) is a CRC code at a time when value x is a bit string. A generating polynomial of this CRC needs to have irreducibility (i.e., the generating polynomial is a primitive polynomial). In addition, symbols “+” and “*” are representative of addition and multiplication in a Galois field. In GF(2), addition and subtraction corresponds to an XOR operation, and multiplication corresponds to an AND operation.

The method of restoring the division data item is as follows.

When any one of division data items A, B, C and D has been lost, the lost division data item can be restored from the other division data items and the first redundancy data a in accordance with the above-described first example. When any one of the division data items A, B, C and D, and the first redundancy data item α is lost, the lost division data item is restored from the second redundancy data item β, assuming that an 8-bit burst error is occurred in the lost division data item.

When two of the division data items A, B, C and D is lost, data restoration can be performed by solving a simultaneous equation relating to the first redundancy data item α and the second redundancy data item β. A description will be given by taking, as an example, the case in, which the division data items B and D is lost.

Since both addition and subtraction are identical in XOR, the equation (1) can be transformed as in equation (3) below.

α+A+C+B=D (3)

In addition, since the distributive law holds true for the CRC with respect to addition (XOR), and both the addition and subtraction are identical in XOR, the equation (2) can be transformed as in equation (4) below.

β+CRC(A+C*4)=CRC(B*2+D*8) (4)

If equation (3) is substituted in equation (4) and transformed, the following equation (5) is obtained.

β+CRC(A+C*4)+CRC((α+A+C)*8)=CRC(B*10) (5)

Since the generating polynomial of CRC is the primitive polynomial, it is a coprime with 10. Hence, B is calculated by making use of the Chinese remainder theorem. Specifically, the left side is divided by 10 (“1010” in the binary system), hence B is calculated. The calculated B is substituted in α+A+C+B=D, and D is found.

The above-described method (first method example) using the exclusive OR and the method (second method example) using both the exclusive OR and cyclic redundancy check are examples of the method of generating the redundancy data item, and the method of generating the redundancy data item is not limited to these examples. In the case of using the redundancy data generating method which enables data restoration even when a plurality of division data items have been lost, a plurality of division data item can be stored in each surveillance camera apparatus 110. In this case, the division number N can be set to be the number of surveillance camera apparatuses 110, or more, which are targets to which the distribution data items are to be transmitted.

In the present embodiment, as described above, the image data item is distributively stored in the surveillance camera apparatuses on the network 130. Specifically, the surveillance camera apparatus 110 generates, from the image data item, (N+J) distribution data items including an N-number of division data items and a J-number of redundancy data items, stores (N+J-K) distribution data items of the (N+J) distribution data items in the storage unit 114, and distributively transmits the other K distribution data items to other surveillance camera apparatuses (also referred to as external devices) 110. In this case, N is an integer of 2 or more, J is an integer of 1 or more, and K is an integer of 2 or more and (N+J) or less. In a specific example, the other K distribution data items are transmitted to a K-number of other surveillance camera apparatuses 110, respectively. In another example, in accordance with the redundancy data generating method, two or more of the K distribution data items may be transmitted to a surveillance camera apparatus 110.

A distribution data item, which does not make sense as a single unit, is stored in each surveillance camera apparatus 110. Thus, even if a malicious person has stolen the surveillance camera apparatus 110, this person is unable to acquire an image data item from the distribution data items stored in the stolen surveillance camera apparatus 110. As a result, divulgence of information due to the theft of the surveillance camera apparatus 110 can be prevented.

Furthermore, by generating at least one redundancy data item based on a plurality of division data items, it is possible to restore the division data item stored in the stolen surveillance camera apparatus 110 by using the division data items and the redundancy data item which are stored in other surveillance camera apparatuses 110. As a result, even in the case where the surveillance camera apparatus 110 is stolen, the image can be reproduced. In other words, it is possible to prevent loss of information (an image) due to theft of the surveillance camera apparatus 110. The larger the number M of surveillance camera apparatuses 110 is, the higher the efficacy of preventing divulgence and loss of information due to theft of the surveillance camera apparatus 110.

Next, the image reproduction apparatus 120 will be described.

As shown in FIG. 1, the image reproduction apparatus 120 includes a communication unit 121, a restoration unit 122 and a combining unit 123.

The communication, unit 121 communicates with an M-number of surveillance camera apparatuses 110 which are connected to the image reproduction apparatus 120 via the network 130. The communication unit 121 requests, from the surveillance camera apparatuses 110, a plurality (N) of division data items and at least one redundancy data item relating to an image to be reproduced, and receives from the surveillance camera apparatuses 110 the plurality of division data items and the at least one redundancy data item relating to the image to be reproduced.

For example, in order to receive the distribution data items relating to the image to be reproduced, the communication unit 121 transmits to the surveillance camera apparatus 110 a request signal including information (e.g., the ID of the surveillance camera apparatus 110 and the time of imaging) for identifying the image to be reproduced. In the case where the storage destinations of the distribution data items are determined in advance, the communication unit 121 can transmit the request signals to the surveillance camera apparatuses 110 in which the distribution data items relating to the image to be reproduced are stored. In the case where the storage destinations of the distribution data items are not determined in advance, the communication unit 121 can transmit the request signals to all the surveillance camera apparatuses 110 by broadcast. When the request signals are transmitted by broadcast, the surveillance camera apparatus 110 can change the transmission destinations of the distribution data items at random, since the image reproduction apparatus 120 does not need to recognize the places where the distribution data items exit.

When the communication unit 121 has failed to receive the division data item, the restoration unit 122 restores the division data item, the reception of which has failed, by using the division data items and the redundancy data item which have been received by the communication unit 121. As the data restoration method, the same method as the above-described method in connection with the redundancy data generating method can be used, and a description thereof is omitted here.

The combining unit 123 generates original image data item by combining an N-number of division data items. The combining unit 123 sends the generated image data item to a display device (not shown). The display device can be provided on the image reproduction apparatus 120, and displays an image based on image data item.

In the case where the distribution data item stored in the surveillance camera apparatus 110 cannot be used because of, for example, theft of the surveillance camera apparatus 110 (e.g., surveillance camera apparatus 110-1), the image reproduction apparatus 120 can restore the division data item stored in, this surveillance camera apparatus 110, based on the division data items and the redundancy data item stored in the surveillance camera apparatuses 110 (e.g., surveillance camera apparatuses 110-2, . . . , 110-M) other than this surveillance camera apparatus 110. Thus, even when the surveillance camera apparatus 110 has been stolen, the image reproduction apparatus 120 can obtain the image data item. In other words, loss of information (an image) due to theft of the surveillance camera apparatus 110 can be prevented.

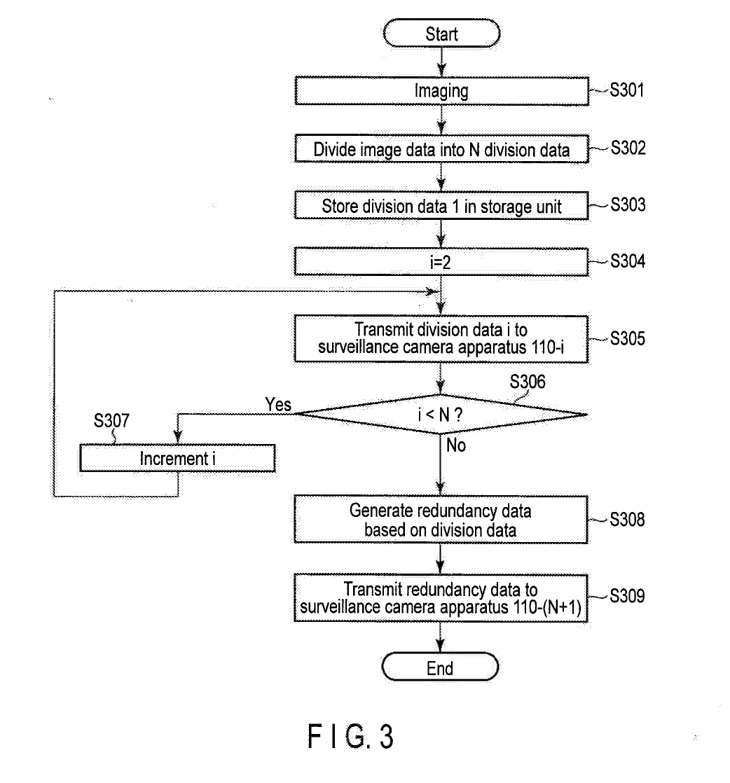

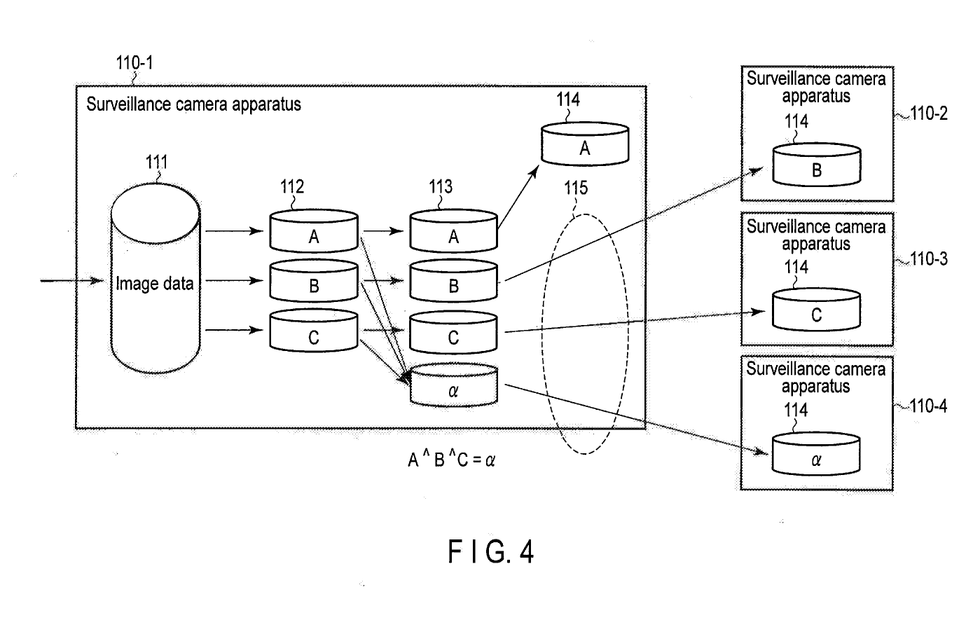

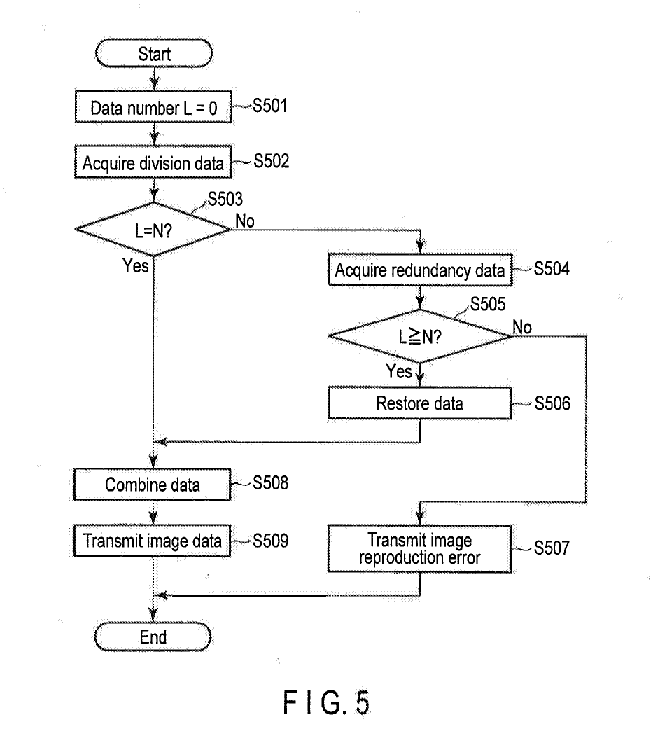

Next, referring to FIG. 3 and FIG. 4, the operation of the surveillance camera apparatus 110 is described.

FIG. 3 schematically illustrates a process procedure of the surveillance camera apparatuses 110. The case is now assumed in which the operational subject, which performs the process illustrated in FIG. 3, is the surveillance camera apparatus 110-1 shown in FIG. 1, the division number N is less than the number M of surveillance camera apparatuses 110, and one redundancy data item is generated. In step S301 in FIG. 3, the imaging unit 111 of the surveillance camera apparatus 110-1 captures an image of a surveillance area and generates image data item. In step S302, the division unit 112 of the surveillance camera apparatus 110-1 divides the image data item into an N-number of division data items. The N division data items are described as a division data item 1, a division data item 2, . . . , a division data item N. In step S303, one (e.g., a division data item 1) of the N division data items is stored in the storage unit 114 of the surveillance camera apparatus 110-1.

Subsequently, the communication unit 115 of the surveillance camera apparatus 110-1 transmits the other N−1 division data items to other surveillance camera apparatuses 110, respectively. Specifically, in step S304, a variable i is set as 2. In step S305, the communication unit 115 transmits a division data item i to a surveillance camera apparatus 110-i. In step S306, it is determined whether the variable i is less than N. If the variable i is less than N, the process advances to step S307 in which i is incremented, that is, i is increased by 1. Thereafter, the process returns to step S305. The process of steps S305 to S307 is repeatedly performed, and if the variable i becomes equal to N, the process advances to step S308.

In step S308, the redundancy unit 113 generates a redundancy data item based on the N division data items 1 to N. For example, the redundancy unit 113 generates a bit string by performing a bitwise exclusive OR operation on the division data items 1 to N, and outputs this bit string as a redundancy data item. In step S309, the communication unit 115 transmits the redundancy data item to a surveillance camera apparatus 110-(N+1).

In the meantime, the process procedure illustrated in FIG. 3 is an example, and the above-described series of processes may be performed in an order different from the order of the procedure illustrated in FIG. 3. For example, the redundancy data generation process illustrated in step S308 may be performed immediately after the division data generation process illustrated in step S303.

In the example shown in FIG. 3, the transmission destinations (storage destinations) of distribution data items are predetermined such that the division data items 1 to N are stored in the surveillance camera apparatuses 110-1 to 110-N, respectively, and the redundancy data item is stored in the surveillance camera apparatus 110-(N+1). In another example, the transmission destinations of distribution data items may be changed at random in a time-division manner in accordance with random numbers which are generated by the random number generator 116. In the case where the transmission destinations of distribution data items are changed at random, the security is further enhanced since the image data item is stored in pieces in the storage units 114 of surveillance camera apparatuses 110.

FIG. 4 schematically illustrates an example of the operation of the surveillance camera apparatuses 110. In the example of FIG. 4, four surveillance camera apparatuses, 110-1, 110-2, 110-3 and 110-4, are illustrated, and the image data item acquired by the surveillance camera apparatus 110-1 is distributively stored in the surveillance camera apparatuses 110-1 to 110-4. In this case, it is assumed that the transmission destinations of the division data items and the redundancy data item are determined in advance. Thus, in FIG. 4, the random number generator 116 is omitted in the surveillance camera apparatus 110-1. Further, the depiction of the elements, other than the storage unit 114, is omitted in the surveillance camera apparatuses 110-2, 110-3 and 110-4.

As illustrated in FIG. 4, an image data item acquired by the imaging unit 111 is divided by the division unit 112 to generate three division data items, A, B and C. The redundancy unit 113 generates a redundancy data item α by performing a bitwise exclusive OR (XOR) operation on the division data items A, B and C. The division data item A is stored in the storage unit 114 of the surveillance camera apparatus 110-1. The division data item B is transmitted to the surveillance camera apparatus 110-2 by the communication unit 115, and is stored in the storage unit 114 of the surveillance camera apparatus 110-2. The division data item C is transmitted to the surveillance camera apparatus 110-3 by the communication unit 115, and is stored in the storage unit 114 of the surveillance camera apparatus 110-3. In addition, the redundancy data item α is transmitted to the surveillance camera apparatus 110-4 by the communication unit 115, and is stored in the storage unit 114 of the surveillance camera apparatus 110-4.

In another example, the surveillance camera apparatus 110-1 may store the redundancy data, item α in the storage unit 114 of the surveillance camera apparatus 110-1, and may transmit the division data items A, B and C to the surveillance camera apparatuses 110-2, 110-3 and 110-4, respectively. In further example, the surveillance camera apparatus 110-1 may transmit the division data items A, B and C to the surveillance camera apparatuses 110-2, 110-3 and 110-4, respectively, and may transmit the redundancy data item α to a surveillance camera apparatus 110-5 (not shown in FIG. 4). Thereby, the degree of freedom of the location of storage of distribution data item can be enhanced.

Next, referring to FIG. 5 to FIG. 8, the operation of the image reproduction apparatus 120 is described.

FIG. 5 schematically illustrates a process procedure of the image reproduction apparatus 120. In step S501 in FIG. 5, a variable (referred to as “data number”) L, which, is indicative of the number of data items received from the surveillance camera apparatuses 110, is initialized. That is, the variable L is set at L=0.

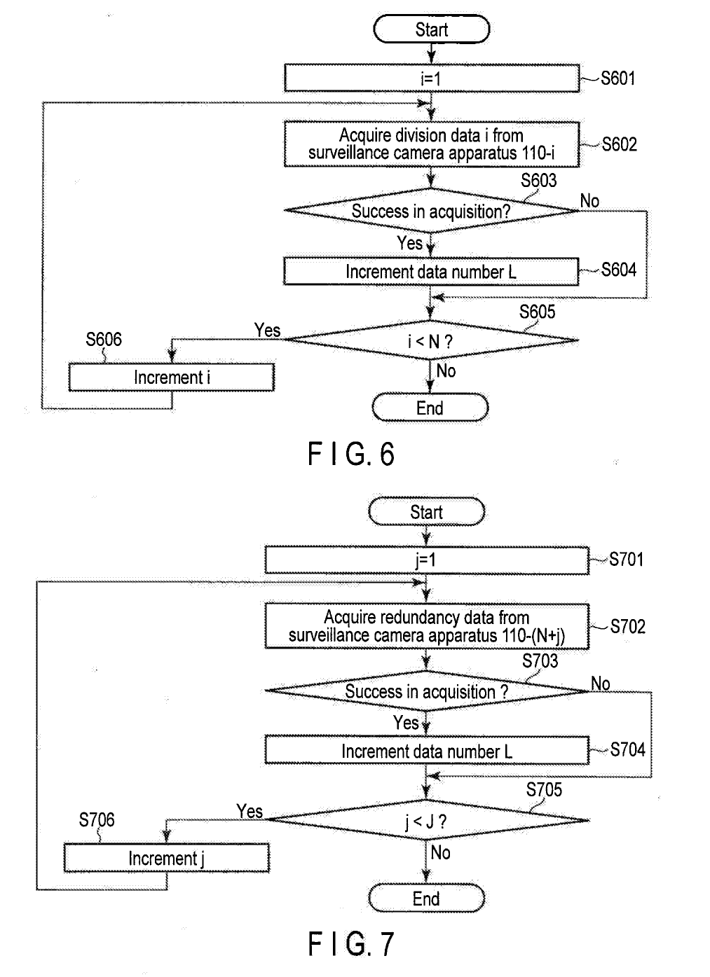

In step S502, the communication unit 121 acquires division data items relating to the image to be reproduced, from surveillance camera apparatuses 110 which are connected via the network 130. A concrete process of step S502 will now be described with reference to FIG. 6. It, is now assumed that an N-number of division data items, which relate to the image to be reproduced, are stored in surveillance camera apparatuses 110-1 to 110-N. In step S601 in FIG. 6, a variable i is set as 1. In step S602, the communication unit 121 acquires a division data item i from a surveillance camera apparatus 110-i. In step S603, it is determined whether the division data item is successfully acquired or not. If the division data item has been successfully acquired, the data number L is incremented in step S604, and the process advances to step S605. If the division data item has failed to be acquired, the process goes to step S605. In step S605, it is determined whether the variable i is less than N. If the variable i is less than N, the variable i is incremented in step S606, and the process returns to step S602. If the variable i becomes equal to N in step S605, the process is completed.

In step S503 in FIG. 5, it is determined whether the data number L is equal to the division number N or not. If the data number L is equal to the division number N, the process advances to step S508. In step S508, the combining unit 123 combines the N division data items and generates the original image data item. In step S509, the combining unit 123 transmits the generated image data item to, for example, the display device (not shown).

In step S503, if the data number L is less than the division number N, the process advances to step S504. That the data number L is less than the division number N means that the division data items relating to the image to be reproduced are not complete. This condition occurs, for example, when the surveillance camera apparatus 110 has been stolen, or a fault has occurred in the surveillance camera apparatus 110.

In step S504, the communication unit 121 acquires the redundancy data item relating to the image to be reproduced, from other surveillance camera apparatus 110. A concrete process of step S504 will now be described with reference to FIG. 7. It is now assumed that a J-number of redundancy data items are stored in surveillance camera apparatuses 110-(N+1) to 110-(N+J), respectively. In this case, J is an integer of 1 or more. In step S701 in FIG. 7, a variable j is set as 1. In step S702, the communication unit 121 acquires a redundancy data item from a surveillance camera apparatus 110-(N+j). In step S703, it is determined whether the redundancy data has been successfully acquired or not. If the redundancy data item has been successfully acquired, the data number L is incremented in step S704, and the process advances to step S705. If the redundancy data item has failed to be acquired, the process goes to step S705. In step S705, it is determined whether the variable j is less than J. If the variable j is less than J, the variable j is incremented in step S706, the process returns to step S702. If the variable j becomes equal to J in step S705, the process is completed.

In step S505 in FIG. 5, it is determined whether the data number L is the division number N or more. If the data number L is less than the division number N, the restoration unit 122 determines that the division data item, the acquisition of which has failed in step S502, cannot be restored, and the process goes to step S507. In step S507, the combining unit 123 transmits an image reproduction, error, which indicates that the image reproduction is impossible, to, for example, the display device (not shown).

In step S505, if the data number L is the division number N or more, the process advances to step S506. In step S506, the restoration unit 122 restores the division data item, the acquisition of which has failed in step S502, by using the redundancy data items acquired in step S504. Thereby, the N division data items are complete. Subsequently, the process goes to step S508. Since the process following step S508 has been described above, the description thereof is omitted here.

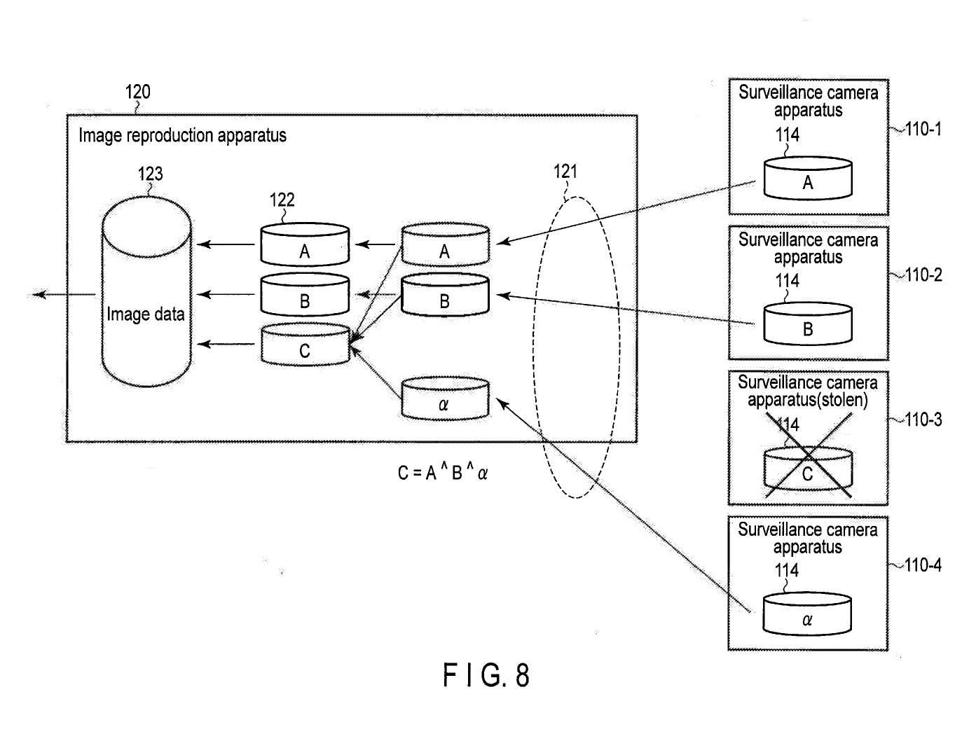

FIG. 8 schematically illustrates an example of the operation of the image reproduction apparatus 120. In the example of FIG. 8, the image reproduction apparatus 120 and four surveillance camera apparatuses 110-1, 110-2, 110-3 and 110-4 are illustrated, and the image reproduction apparatus 120 reproduces the image data item which is distributively stored in the surveillance camera apparatuses 110-1, 110-2, 110-3 and 110-4. In FIG. 8, elements other than the storage unit 114 are omitted in the surveillance camera apparatuses 110-1, 110-2, 110-3 and 110-4.

As illustrated in FIG. 8, the communication unit 121 tries to acquire division data items A, B and C from the surveillance camera apparatuses 110-1, 110-2 and 110-3. In this example, the communication unit 121 acquires the division data items A and B from the surveillance camera apparatuses 110-1 and 110-2, but fails to acquire the division data item C from the surveillance camera apparatus 110-3 because of theft of the surveillance camera apparatus 110-3. In this case, the communication unit 121 acquires a redundancy data item α from the surveillance camera apparatus 110-4. The restoration unit 122 restores the division data item C, the acquisition of which has failed, based on the division data items A and B and the redundancy data item α. The combining unit 123 generates an image data item by combining the division data items A, B and C, and outputs the image data item.

As has been described above, according to the present embodiment, the image data item is distributively stored in the surveillance camera apparatuses on the network. Thereby, divulgence and loss of information due to theft of the surveillance camera apparatus 110 can be prevented.

Note that the above-described embodiment is an example, and various modifications, as described below, for instance, may be made.

A server apparatus (not shown), which provides a cloud file storage service and which corresponds to an external device, may be provided in the surveillance system 100, and some of the distribution data items may be stored in this server apparatus. Thereby, the risk of theft can be reduced.

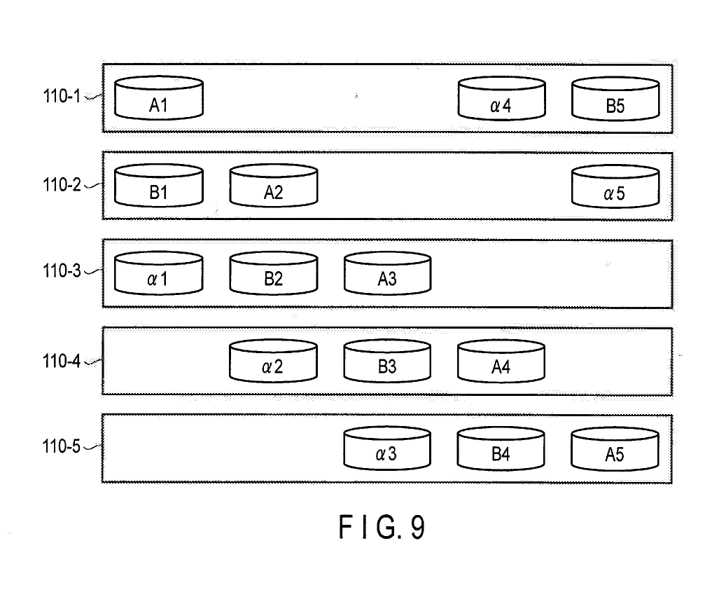

As regards the transmission/reception of division data items and a redundancy data item, different surveillance camera apparatuses 110 may be designated for transmission and reception. FIG. 9 schematically illustrates an example of distributed storage. In the example of FIG. 9, five surveillance camera apparatuses, 110-1 to 110-5, are illustrated. In FIG. 9, data items Ai and Bi are indicative of division data items generated by a surveillance camera apparatus 110-i, and a data item ad is indicative of a redundancy data item generated by the surveillance camera apparatus 110-i. For example, data items A1 and B1 are division data items generated by the surveillance camera apparatus 110-1, and a data item α1 is indicative of a redundancy data item generated by the surveillance camera apparatus 110-1.

In this example, a division, data item A1 is stored in the surveillance camera apparatus 110-1, a division data item B1 is stored in the surveillance camera apparatus 110-2, and a redundancy data item α1 is stored in the surveillance camera apparatus 110-3. A division data item A2 is stored in the surveillance camera apparatus 110-2, a division data item B2 is stored in the surveillance camera apparatus 110-3, and a redundancy data item α2 is stored in the surveillance camera apparatus 110-4. A division data item A3 is stored in the surveillance camera apparatus 110-3, a division data item B3 is stored in the surveillance camera apparatus 110-4, and a redundancy data item α3 is stored in the surveillance camera apparatus 110-5. A division data item A4 is stored in the surveillance camera apparatus 110-4, a division data item B4 is stored in the surveillance camera apparatus 110-5, and a redundancy data item α4 is stored in the surveillance camera apparatus 110-1. A division data item A5 is stored in the surveillance camera apparatus 110-5, a division data item B5 is stored in the surveillance camera apparatus 110-1, and a redundancy data item α5 is stored in the surveillance camera apparatus 110-2.

As illustrated in this example, even if the surveillance camera apparatus 110-2 stores the distribution data item which has been generated by the surveillance camera apparatus 110-1, it is not always necessary for the surveillance camera apparatus 110-1 to store the distribution data item which has been generated by the surveillance camera apparatus 110-2. In addition, neither the surveillance camera apparatus 110-4 nor the surveillance camera apparatus 110-5 stores the distribution data item generated by the surveillance camera apparatus 110-1. In this manner, it is not necessary that the distribution data items generated by a certain surveillance camera apparatus be distributively stored in all the surveillance camera apparatuses 110 on the network 130. Thereby, even if the number of surveillance camera apparatuses 110 increases, the configuration of distributed storage can be flexibly maintained.

Further, although the image reproduction apparatus 120 is depicted as an independent apparatus in FIG. 1, the Image reproduction apparatus 120 may be incorporated in any one of, or in each of, the surveillance camera apparatuses 110. For example, the image reproduction apparatus 120 may be implemented as software, with the use of hardware of the surveillance camera apparatuses 110, such as a CPU (Central Processing Unit), a memory and a network interface. Thereby, the configuration of the apparatus can be simplified.

In the case where a sound recording device, such as a microphone, is mounted in the surveillance camera apparatus 110, the surveillance camera apparatus 110 may perform a process (division, redundancy, etc.) on a recorded sound data item, like an image data item. Thereby, divulgence of information can also be prevented with respect to data other than image data.

The storage unit 114 and communication unit 115 may be used in combination with general encryption technologies. Thereby, the risk of information divulgence can further be reduced.

The part for processing an image data item, which includes the division unit 112, the redundancy unit 113, the storage unit 114, the communication unit 115 and the random number generator 116, may be implemented as an independent information processing apparatus. In addition, in the above-described embodiment, although the description has been given of the case in which the information processing apparatus is applied to the surveillance camera apparatus 110, the information processing apparatus is also applicable to other apparatuses. The data, which is handled by the information processing apparatus, is not limited to image data, and may be any kind of digital data. As the digital data, for example, digital data including personal information, confidential information, etc., is assumed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a division unit configured to divide a digital data item into a plurality of division data items;
a redundancy unit configured to generate at least one redundancy data item for data restoration based on the plurality of division data items; and
a communication unit configured to transmit to a plurality of external devices two or more of three or more distribution data items, the three or more distribution data items corresponding to the plurality of division data items and the at least one redundancy data item.

2. The apparatus according to claim 1, wherein the at least one redundancy data item includes a first redundancy data item, and
the redundancy unit is configured to generate the first redundancy data item by performing a bitwise exclusive OR operation on the plurality of division data items.

3. The apparatus according to claim 1, wherein the at least one redundancy data item includes a first redundancy data item and a second redundancy data item, and
the redundancy unit comprises a first redundancy unit configured to generate the first redundancy data item by performing a bitwise exclusive OR operation on the plurality of division data items, and a second redundancy unit configured to generate, as the second redundancy data item, a cyclic redundancy check code for the plurality of division data items.

4. The apparatus according to claim 1, further comprising a storage unit configured to store at least one of the three or more distribution data items,
wherein the two or more distribution data items are other than the at least one distribution data item stored in the storage unit among the three or more distribution data items.

5. The apparatus according to claim 1, wherein a number of the plurality of division data items is greater than a number of the plurality of external devices.

6. The apparatus according to claim 1, wherein the communication unit is configured to change transmission destinations of the two or more distribution data items at random.

7. A surveillance camera apparatus comprising:
the information processing apparatus according to claim 1; and
an imaging unit configured to generate the digital data item by capturing an image.

8. An image reproduction apparatus operating in a system in which a plurality of division data items obtained by dividing an image data item and at least one redundancy data item for data restoration, which is generated based on the plurality of division data items, are distributively stored in a plurality of external devices, the apparatus comprising:
a communication unit configured to receive the plurality of division data items and the at least one redundancy data item from the plurality of external devices;
a restoration unit configured to restore, if the communication unit fails to receive at least one of the plurality of division data items, the at least one division data item based on the at least one redundancy data item and one or more of the plurality of division data items different from the at least one division data item failed to receive; and
a combining unit configured to obtain the image data item by combining the plurality of division data items.
